(19) United States
(12) Patent Application Publication
(10) Pub. No.: US 2015/0142984 A1
(43) Pub. Date: May 21, 2015

(54) System and Method for Security over a Network

(71) Applicant: Nicolas Thomas Mathieu Dupont, Orlando, FL (US)

(72) Inventor: Nicolas Thomas Mathieu Dupont, Orlando, FL (US)

(21) Appl. No.: 14/085,774

(22) Filed: Nov. 20, 2013

(51) Int. Cl. H04L 29/08

(52) U.S. Cl. CPC H04L 67/14
USPC 709/228

(57) ABSTRACT

A system and method is disclosed for communicating a data request between a first device and a second device over a network, the first device and second device each having at least a processor, storage, memory and input and output components, the method comprising sending from the communication output of the first device a data request having a request header comprising at least a unique primary device identifier associated with the first device, receiving, at an intermediary the data request, accessing, at the intermediary, a database having the primary device identifier and a unique alternate device identifier associated with the first device, sending to the second device the data request having a header comprising at least the alternate device identifier associated with the first device. The second device may also have a primary device identifier and alternate device identifier.

### COPYRIGHT

Copyright—A portion of the disclosure of this document contains material that is subject to copyright protection. The copyright owner has no objection to the facsimile reproduction by anyone of the patent document or the patent disclosure, as it appears in publically available Patent and Trademark Office patent files or records, but otherwise reserves all copyright rights whatsoever. The following notice applies to the software, data, and/or screenshots which may be described below and in the drawings that form a part of this document: Copyright Nicolas T. M. Dupont, All Rights Reserved.

### BACKGROUND

Encryption is a type of cryptography which allows for the storage of files on a permanent storage device, not in its pure state, but in a coded state that can only be opened by an outside stimulus, for example, a password, smartcard, pin code, etc. Some examples are the AES encryption standard on permanent storage and the SSL (secure sockets layer) for internet data transfers.

Current encryption standards are key based, meaning that a key is needed in order to decrypt a file. One of the limitations in key based security systems is susceptibility to “brute force” hacking. Hacking refers to any unauthorized remote access to a computer terminal. Brute force hacking is the automatized, repeated trial of various key combinations until the correct one is found. The military grade AES 256 and 512 systems were once deemed unhackable, but now programs can guess the key by analyzing the data or the systems may still be hacked by brute force.

Another issue with the current internet protocol is the ability hackers to intercept data being transmitted by using a false proxy to emulate the intended recipient's IP address. Basically, the unauthorized third party could receive transmissions intended for one party by emulating the IP address of that party. There is currently no protocol for data transmissions that is device-based or hardware based.

### BRIEF DESCRIPTION OF THE DRAWINGS

FIG. 1 illustrates data transmission with the Internet Protocol.

FIG. 2 illustrates a data transmission according to an embodiment.

FIG. 3 is a detail view of an identifier chip according to an embodiment.

FIG. 4 illustrates a view of secure data transmissions according to an embodiment.

FIG. 5 is an exemplar client server data exchange in accordance with an embodiment.

FIG. 6 illustrates an exemplar process occurring within a database showing communications with a client and a communicator.

FIG. 7 shows the request header in accordance with the preferred embodiment.

FIG. 8 shows the reply header in accordance with the preferred embodiment.

FIG. 9 illustrates an exemplar device having an identifier chip for implementing the methods described in accordance with an embodiment.

### DETAILED DESCRIPTION

Methods, systems, and apparatus, (referred to collectively for convenience as the “system”) are disclosed for secure data transmissions over a network. The system is an improvement over key based encryption systems, recognizing that the reliance on key based encryption systems is itself a limitation of current encryption systems. There are currently no non-key based encryption systems. The disclosed system and method is a hardware based security system, rather than address based or key based.

There are no device-based security systems for network communications because it has been presumed there are no feasible ways to implement such a system. The present system preferably employs chip based identifiers physically housed on a terminal, such as a user device capable of sending and/or receiving data requests over a network such as the internet. These chip identifiers house a primary device identifier, “PDI.” The device is in communication with a communicator at an intermediary for sending and receiving data requests packaged with at least one second identifier (the alternate device identifier, “ADI”) in the request header. A request is sent through the intermediary whereupon the request is packaged with an ADI corresponding to either (1) the transmitting terminal's PDI or (2) the receiving terminal's PDI (if the receiving terminal also has an identifier chip) or both. A receiving terminal (such as a server) may also have an identifier chip, having its own PDI. In this case, transmission from the server to the receiving terminal would use an ADI corresponding to the server's PDI for transmission to and from the server.

Because requests going between the server and user device are channeled through an intermediary and because the request can only be opened by the recipient having the PDI corresponding to the ADI, the requests cannot be intercepted by a remote third party at another terminal. This is because a hacker cannot emulate a hardware based PDI in the manner than an IP address is emulated. The hacker's terminal will not have the identifier chip corresponding to that particular PDI. As explained below, the system is interoperable with certain encryption systems capable of linking to, for example, an event handler for instructing the terminal's computing system to require the PDI-check prior to outputting a password or encryption key.

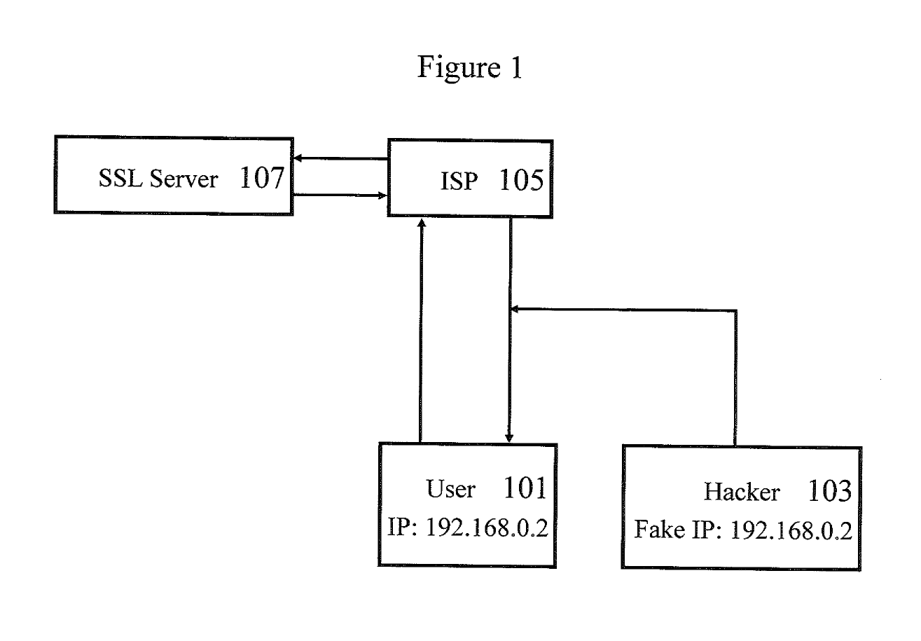

The system is described in more detail in the following paragraphs. FIG. 1 is included to illustrate the current IP system. The terminal of a user 101 communicates with a server 107 via internet service provider (“ISP”) 105. Under the IP, the user is assigned an IP address for routing communications to the user 101. Hackers emulate the IP address 103 in order to redirect transmission intended for the user 101 to the hacker 103.

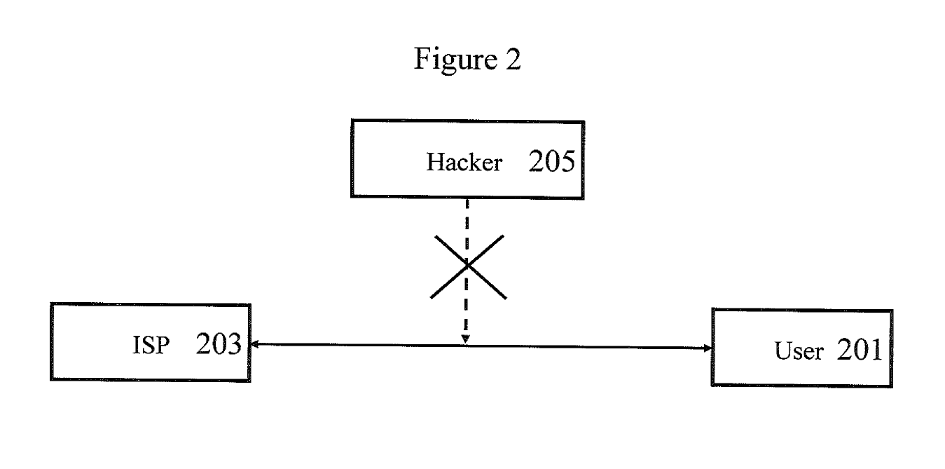

FIG. 2 is an illustration of communications between an ISP 203 and a user device 201 employing the hardware based identifier of the system. The connection between the user 201 and ISP 203 may be wireless or a physical link cable of receiving and emitting data. Because the hacker 205 does not have the unique PDI of the user device 201. This is because the data is encrypted using a suitable, available encryption system and the “key” for the encryption system is in effect the PDI at a first layer of security. Terminals receiving data routed to a particular device (as identified via its PDI) would not be able to decrypt or access the data.

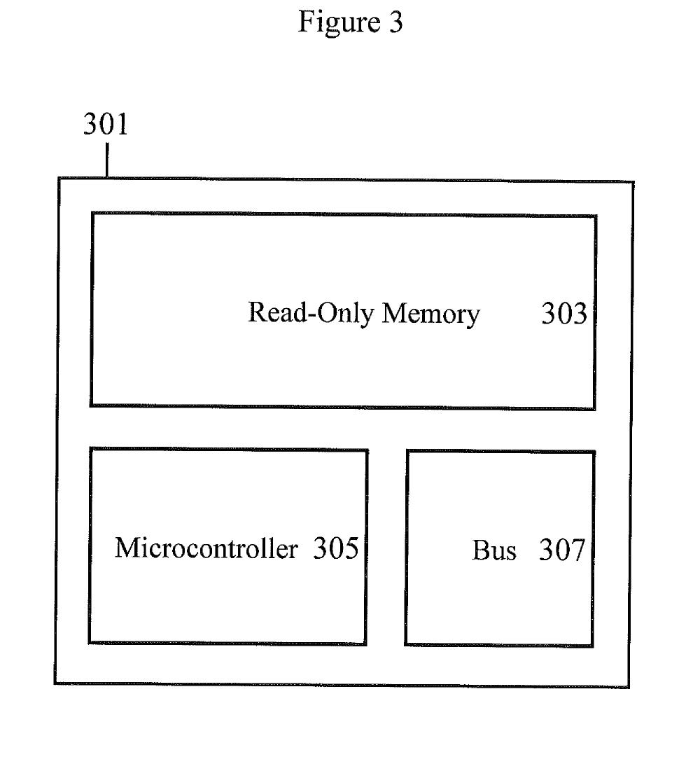

FIG. 3 is a detail view of an embodiment an identifier chip. This chip may be located on a printed circuit board (“PCB”). Because the identifier is housed in a chip in the preferred embodiment, the entire PCB communicates with the user device via a connection on the PCB to the componentry of the user device. The architecture of a user device having the PCB is detailed below, starting at paragraph 41. The chip may also be coupled with a network interface card in communication and embodied on the user device. The chip may be located anywhere on a motherboard of the user device, so long as connects to any means for network interface (in other words portions on the user device handling incoming and outgoing data/input/output 919).

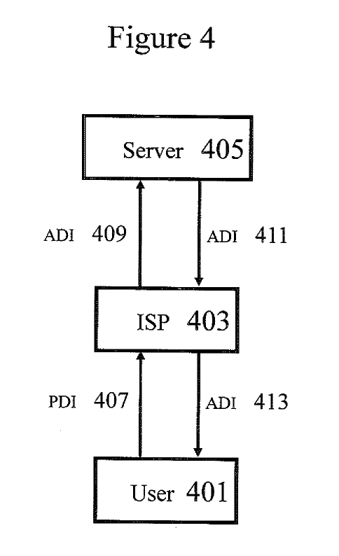

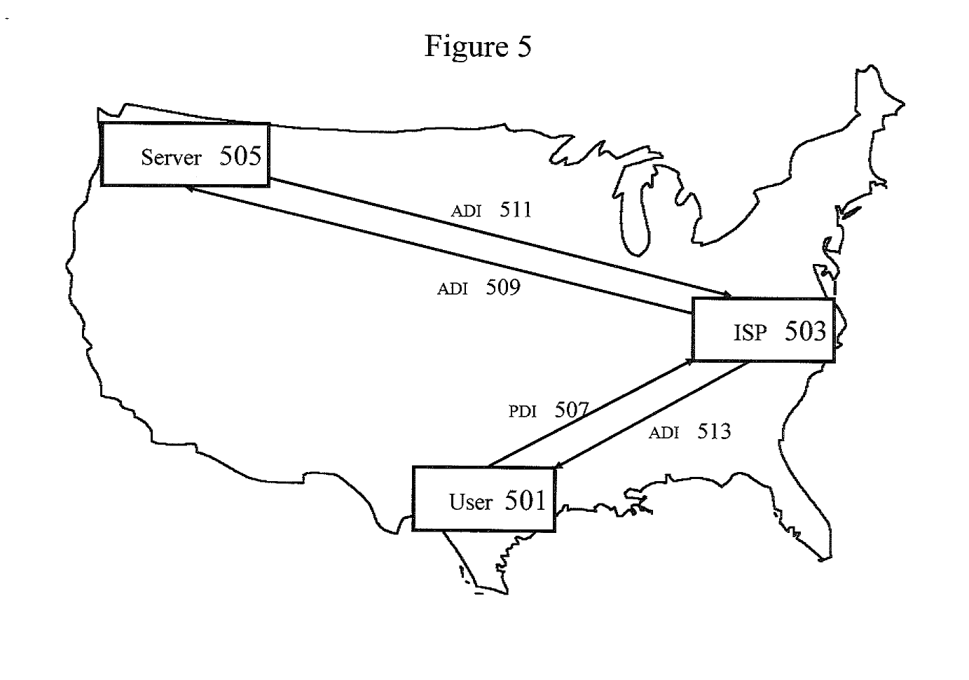

FIGS. 4 and 5 show the routing protocol of the system, in chart form v. geographical form, respectively. Although these figures show user device-server communications as examples, any two or more terminals may communicate using the methods described. The data sent through this protocol are encrypted data requests, as described below.

Starting with FIG. 4, the method for transmitting data in accordance with the system in an embodiment is as follows:

1. A request from a user device 401 (“user device” including but not limited to a computer, tablet, or smartphone) to a communicator within an intermediary, such as an ISP 403. The communicator is a device in communication with the user device (either remotely such as housed at the ISP or directly housed on the user device) capable to communicate with other terminals. The “other terminal” in FIG. 4 is server 405. The communicator preferably houses a database having stored thereon individual device PDI's and their corresponding ADI's. In this disclosure, “user” refers to the user device utilized by a user to send data requests over a network.

The user device houses a chip, preferably in the form of chip 301, having stored in memory 303 thereon an identifier unique to the chip 301. This identifier is the PDI. The PDI is preferably a 256-bit identifier. The identifier may be a serial or identification number comprising a text string or alpha and/or numeric characters. A 256 bit identifier is used in the preferred embodiment, as it allows for multiple undecillion possible PDI's to be assigned to various terminals, a more than sufficient number for providing the terminals currently in existence with their own unique identifier. However, any size identifier which permits adequate number of distinct identifiers may be used.

2. Next, the communicator (preferably housed within ISP 403) sends the user's data request, packaged along with a predetermined alternate device identifier (ADI) along to a server for communicating the request to the receiving terminal. The ADI used is preferably communicated to the communicator by an intermediary server (or ISP) which houses a database having stored thereon the predetermined Alternate Device Identifier (ADI) which is associated with the given user device's PDI.

3. Request from ISP 403 to server 405: Going from ISP 403 to server 405, the data request is packaged with the ADI 409 (via a header). The ADI 409 that is sent from ISP 403 to the server may be the ADI associated with the server's unique PDI. However, if the server does not have an identifier chip (and thus no PDI/ADI), the header will include the ADI of the user device 401 and the server address for communications between the ISP 403 and the server 405.

4. Request from server 405 to the user 401 via ISP 403: In order to send a response request, the server (having its own chip 301 and corresponding PDI) will send its request through a communicator (housed either in direct communication with the server or housed in ISP 403). The communicator will assign the server's request its unique ADI 411 (by the same as the process in #2) to the ISP 403. ISP 403 then routes the server's message to the user device 401 by using the user's ADI 413. During this communication, only a device having the user's PDI associated with the ADI 413 may decrypt the communication. In other words, the return request (originating from server 405) is next sent back to the user device 401 via the same or similar communicator and opened only if the receiving device 401 has the physical chip loaded thereon having the corresponding PDI.

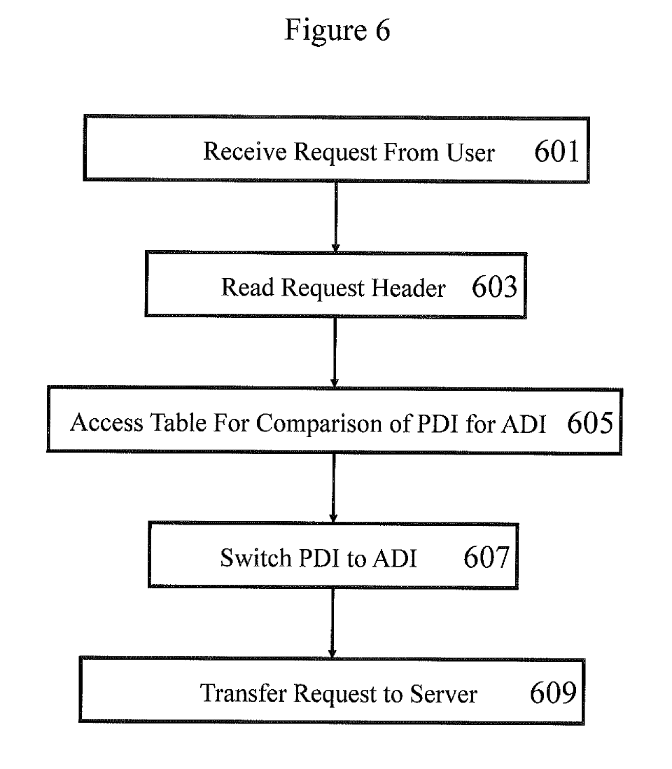

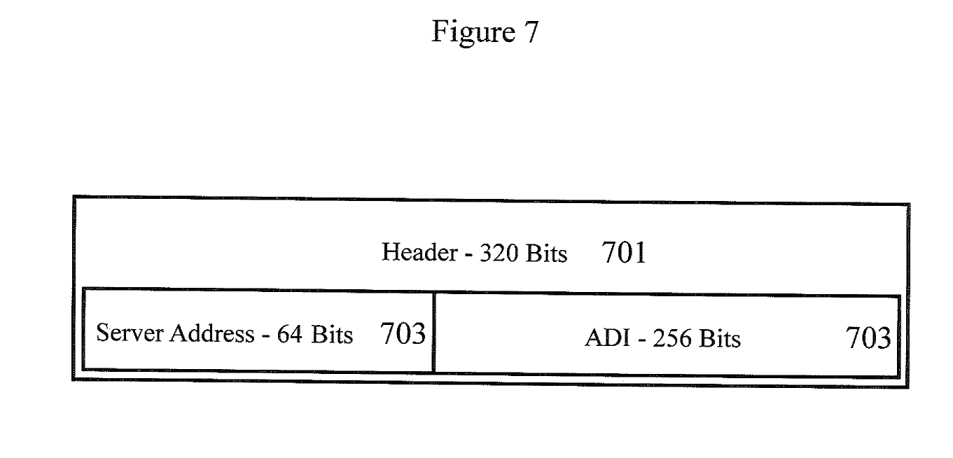

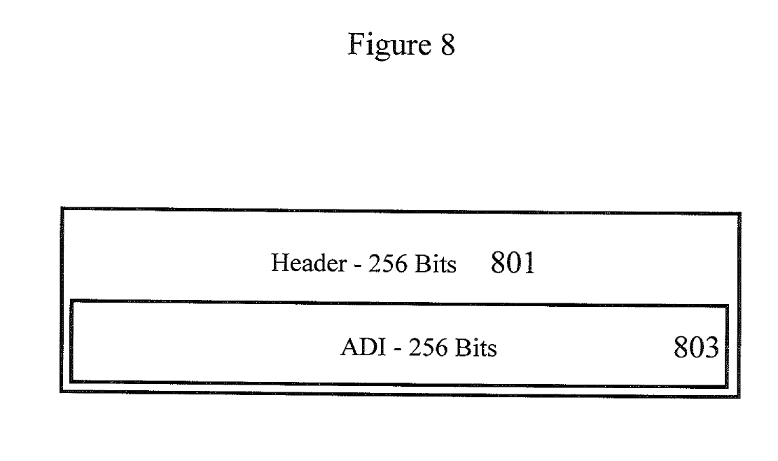

Data requests (also referred to simply as “requests”) are preferably packaged and routed according to the process shown in FIG. 6 using the headers shown in FIGS. 7 and 8. First, the request is received from a user device 601 intended for a destination, such as a server. The request contains a header having the PDI 603 associated with the chip 301 housed on the user device. At a communicator, a table (which may be a database) is accessed 605 having stored thereon ADI's associated with the PDI. The header having the PDI is then replaced with header 701, having the ADI along with the server address 703. The request is then transferred to the server 609.

The reply (server to user) has a header of 256 bits which is the alternative device identifier 803 associated with the user. The user's ADI is used in this instance if the communication is from ISP 503 to user 501. This ADI serves to route the reply to the user 401, 501.

The process for accessing the chip can also be explained as follows: a request sent to the server 505 from the user 501. This request will have a header 701 of 320 bits made up of the server address 703, which is 64 bits and the ADI 509 pertaining to the user 703 (32 bytes). (the data request may also include a footer of 8 bits or one byte).

In FIG. 5, server 505 may be a server for example to the retailer, Amazon, which is located in Washington State. The ISP 503 may be located in New York and may further be a SQL live database hosted on a client there, serving as a central point or physical link of contact between the user 501 located in Texas and the server 505. This intermediary 503 is not limited to one intermediary. There may be a plurality of intermediaries for housing the database of ADI/PDI information. Note that the communicator (not pictured) may be housed in the ISP 503 or there may be a client version of the ISP servers for accessing the identifiers and sorting them as temporary files for using with requests.

An important part of the system disclosed is its interoperability with many encryption systems, particularly key based encryption systems. This is important, as if a data request was intercepted, the hacker would not be able to read the data because the data would be encrypted and the only way to decrypt it would be to use an encryption key which is based—in this system—on the hardware based PDI. Encryption systems in their present form use encryption keys which are basically passwords. As mentioned, passwords can be determined using “brute force” hacking, or basically bots running a loop script to attempt several possible password combinations. This is in part what rendered the AES 64 bit encryption standard obsolete.

Stated another way, rather than encryption keys being exchanged or based off a smartcard, they based off the chip identifier (PDI). The AES 256 bit encryption standard requires a passcode in order to decrypt or open a file. Other technologies that are AES compatible use a smart card or sensor that is AES compatible, which could also be retinal or fingerprint systems allowing the file to be opened. The PDI in the present system could serve as the encryption key used in the AES system. Using the present system, the password formerly used as the encryption key would be instead associated with a PDI as an initial check. Without having the identifier chip on its remote terminal, a hacker would not be able to pass the first layer of security. This is the requirement of having the PDI in addition to the encryption system's key in order to decrypt the data request.

Coordinating the chip based security layer can be integrated with available encryption systems in many ways. The easiest way is the use of an event handler (the graphical user interface on the backend of the operating system of a user device) having a library for allowing the event handler to output the password for an AES 256-encrypted data request if certain conditions are first met. These conditions are that the receiving terminal has the PDI associated with the ADI in the header of the incoming data request. For example, if the data sent by the above protocol was encrypted by an AES 256 standard had a password of 1234, the event handler may communicate with PCB 301 (having the identifier chip housed thereon) instructions for outputting the password using a conditional statement if, for example, the correct ADI was received. Using this mechanism, password 1234 would only be output in the event the receiving terminal has the PDI. A hacker would not have the PDI, but the user device would have the PDI.

The identifier chip may be located on PCB 301 linked to instructions stored in memory for instructing the operating system to decrypt a data request if certain conditions are met (namely the matching of an ADI with a PDI). This is done by instructing the encryption suite or other third party encryption software to pull up the encryption key or password used in that system if the PDI is present. This system improves smartcards because the use of the ADI and PDI are used not only with the encryption suite (used by a user or server), but also for data routing and data traffic. The hardware based identifiers used for routing renders the web more efficient because of a lack of the ability for third parties to emulate addresses used in the present day IP protocol.

A third party seeking to intercept data may presently use a false proxy 103 to emulate the IP address. The chip based system disclosed forecloses that possibility because each device will be seen for its actual identity, rather than by a false proxy using the 256 bit identifiers. Further, the chips may be used with existing encryption systems to add an additional layer of physical identity, thereby enhancing the encryption systems, particularly key-based systems.

Variations may be made by those skilled in the art and are contemplated and made part of this disclosure. For example, the ADI is preferably assigned to the chip, but not saved to the chip.

PDI's are preferably assigned at the chip manufacturer. However, because data going in and out of the manufacturer will also be subject to PDI/ADI and encrypted with any compatible encryption suite (for instance one compatible with the event handler described above), a hacker could not intercept messages containing a database containing information concerning PDI's and their associated ADI's because the hacker would not have the corresponding PDI on its system enabling the hacker to access and decrypt the data.

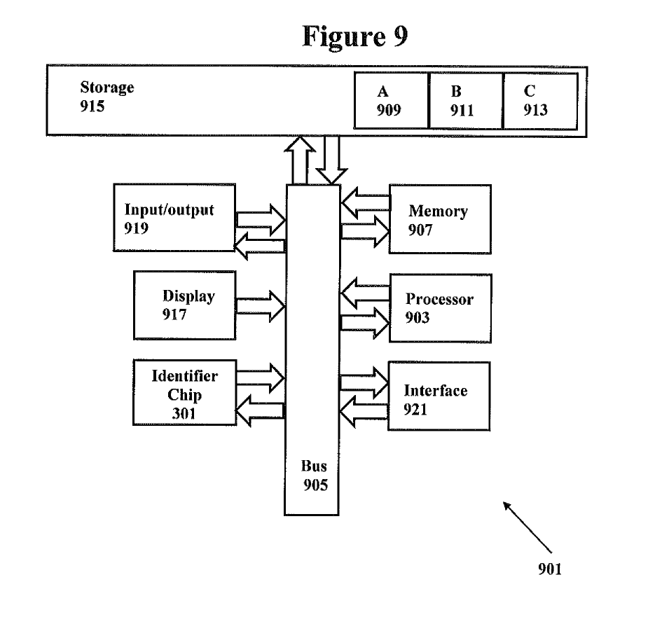

The protocol is intended to work with a PCB 301 or other embodiment of a chip based PDI loaded on the actual devices (such as user device 401 or server 405 or device 901) to enable those devices to communicate in accordance with the above system and method. There are various configurations for the chip having the same functionality. The system preferably includes the chip (which may be housed on a separate PCB 301), coupled with the input/output of a device (the exemplar device shown in FIG. 9).

The ADI may be static or dynamic. For instance the ADI's could be changed every 24 hours and stored on at least one database at ISP 403.

The system may be compatible with current networks. For instance, for servers not having chips with PDI's in accordance with the preferred embodiment, requests may still be sent to those servers under existing protocols, they simply will not have the added layer of security of the ADI/PDI.

An example hardware architecture for the user device or server or other device for sending and receiving data requests in accordance with the system and methods above is shown in FIG. 9 (for the purpose of this example, this will be referred to as the user device). These blocks or a subset of these blocks may be integrated into a device, such as a smartphone or tablet for performing the described methods. A computing device, which may be a network of computing devices, can be used to practice the embodiments described. In one embodiment the user device includes at least a central processing unit (or processor) 903, memory 907, storage 915, and input/output devices 919, each of which are interconnected via a system bus 905 that couples various system components including the memory to the processor. Modules can be configured to control the processor to process instructions for execution within the system. For instance, the system preferably comprises a chip 301 including firmware (ex. Module A 909) for performing the packaging of a data request with the appropriate header for transmission. Alternatively, these steps may be performed by separate modules, such as Module B storing instructions for performing the decryption of incoming data and for performing a check whether the data received and the user device have matching ADI/PDI's, and Module C 2313 for performing related functions. In this Figure, PCB 301 is included and deemed to include at least all the components shown at 301 in FIG. 3.

Storage 915 may be remote or local to the system. The processor is capable of processing instructions stored in memory or storage and may optionally display graphical information on an output device (such as the display 917 of a user interface 921 (whereby a user may interact with the system to select files to be transmitted), said output device preferably comprising output devices associated with a user device used by a user, such as a tablet or smartphone.

Memory 907 may include multiple different types of memory with different performance characteristics and may be read only memory and random access memory. The disclosure may operate on a computing device with more than one processor or on a group of networked computing devices, servers, or a combination of both. The system can include clients and servers. A client and server are usually remote and interact via a communication network and programmed to interact in a client/server relationship.

Processor 903 may include any general purpose processor and a hardware module or software modules stored in storage, configured to control the processor as well as a special-purpose processor where program instructions are incorporated into the actual processor design. The system may also comprise a smaller device processor as well, powered by a microcontroller. The processor may be a completely self-contained computing system, containing multiple cores or processors, a bus, memory controller, cache, etc. A multi-core processor may be symmetric or asymmetric. The preferred system embodiment is presented as including individual functional blocks including functional blocks labeled as a “processor” or processor. The functions of one or more processors may be provided by a single shared processor or multiple processors. (The term “processor” should not be construed to refer exclusively to hardware capable of executing software, and as used herein is also referred to as a “processing device.”) Illustrative embodiments may include microprocessor and/or digital signal processor hardware, read only memory for storing software performing the operations discussed above, and random access memory for storing results.

Bus 905 may be any of several types of bus structures including a memory bus or memory controller, a peripheral bus, and a local bus using any of a variety of bus architectures. A basic input/output (BIOS) stored in read only memory or the like, may provide the basic routine that to assist in the transfer of information between elements within the computing device, such as during start-up. The computing system further includes storage such as a hard disk drive, a magnetic disk drive, an optical disk drive, tape drive or the like. Storage can include software modules, for example, for controlling the processor 903. Other hardware or software modules are contemplated. The storage device is connected to the bus by a drive interface. Input data to be compressed may be fed from the storage device having a plurality of memories connected to corresponding subprocessors. The drives and the associated computer-readable storage media provide nonvolatile storage of computer-readable instructions, data structures, program modules and other data for the computing device.

Input/Output 919 may be a connection to a communication channel (for example 507, 513) for the receipt and transmission of data, respectively.

In one embodiment, a hardware module that performs a particular function includes the software component stored in a non-transitory computer-readable medium in connection with the necessary hardware components, such as the processor, bus, display (optional), and so forth, to carry out the function. The system may include a user interface for allowing users to choose certain files to be compressed (not pictured), visible to a user via a display. As mentioned previously, the system may further comprise a display 917 or interface 921 or both whereby a user may interact with the system, for example, to select files to compress or transmit wirelessly or both. In embodiments including a display, “display” refers to visually perceptible display on a display device (such as a networked computing device for example, an end user's device) resulting from a tangible computer filed stored in its memory. This may originate from across a network, such as the Internet, a wireless communication network, or a system of connected networked computers. The display includes devices upon which information can be displayed in a manner perceptible to a user, such as a touchpad or touchscreen display, a computer monitor, an LED display, and the like means known in the art for producing visually perceptible output. The basic components are known to those with skill in the art and appropriate variations are contemplated depending on the type of device; the term “computing device” refers to any device, such as a user device, with processing capability such that it can execute instructions, for example, tablets, smartphones, PC computers, servers, telephones, and other similar devices.

To enable user interaction with the computing device, an interface 921 represents any number of input mechanisms, such as a microphone for speech, a touchscreen for gesture or graphical input, keyboard, mouse, motion input, speech, etc. An output device can also be one or more of a number of output mechanisms known to those of skill in the art. In some instances, multimodal systems enable a user to provide multiple types of input to communicate with the computing device. The communications interface generally governs and manages the user input and system output. There is no restriction on operating on any particular hardware configuration and the basic componentry here may easily be substituted for improved hardware or firmware arrangements as they are developed.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system can practice all or part of the disclosed methods and/or can operate according to instructions in the recited non-transitory computer-readable storage media. Such logical operations can be implemented as modules configured to control the processor to perform particular functions according to the programming of the module. For example, modules controlling the processor to perform particular steps or a series of steps, however additional or fewer modules may be used. These modules may be stored on the storage and loaded into random access memory or memory at runtime or may be stored as would be known in the art in other computer-readable memory locations.

Portions of various embodiments of the present invention may be provided as a computer program product, which may include a computer-readable medium having stored thereon computer program instructions, which may be used to program a computer (or other electronic devices) to perform a process according to the embodiments of the present invention. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions. Although the exemplary embodiment described herein employs the hard disk, storage, those skilled in the art appreciate that other types of computer-readable media may also be used in the exemplary operating environment. Non-transitory computer-readable storage media expressly exclude media such as energy, carrier signals, electromagnetic waves, and signals per se.

What is claimed is:

1. A method for communicating a data request between a first device and a second device, the first device and second device each having at least a processor, storage, memory and input and output components, the method comprising:
sending from the communication output of the first device a data request having a request header comprising at least a unique primary device identifier associated with the first device,
receiving, at an intermediary the data request;
accessing, at the intermediary, a database having the primary device identifier and a unique alternate device identifier associated with the first device;
sending to the second device the data request having a header comprising at least the alternate device identifier associated with the first device.

2. The method as in claim 1, wherein the primary device identifier is stored in memory housed on a chip within the first device.

3. The method as in claim 1, wherein the second device is a server.

4. The method as in claim 1 wherein the request header also includes the IP address of the second device.

5. The method as in claim 1, wherein the alternate device identifier is static.

6. The method as in claim 1, wherein the alternate device identifier is dynamic.

7. The method as in claim 1, wherein the data request is encrypted in accordance with a predetermined encryption system and the primary device identifier serves as an encryption key.

8. A method for communicating a data request between a first device and a second device, the first device and second device each having at least a processor, storage, memory and input and output components, the method comprising:
sending from the communication output of the first device a data request having a header comprising at least a unique primary device identifier associated with the first device,
receiving, at an intermediary the data request;
accessing, at the intermediary, a database having the primary device identifier and a unique alternate device identifier associated with the first device;
sending to a second intermediary the data request;
accessing at the second intermediary a unique alternate device identifier associated with the second device;
sending the data request to the second device, the data request having a header comprising at least the alternate device identifier associated with a primary device identifier of the second device.

9. The method as in claim 8, wherein the primary device identifier is stored in memory housed on a chip within the first device.

10. The method as in claim 8, wherein the second device is a server.

11. The method as in claim 8 wherein the request header also includes the IP address of the second device.

12. The method as in claim 8, wherein the alternate device identifier is static.

13. The method as in claim 8, wherein the alternate device identifier is dynamic.

14. The method as in claim 8, wherein the data request is encrypted in accordance with a predetermined encryption system and the primary device identifier of the first and second devices serves as an encryption key.
